(19) United States
(12) Patent Application Publication
(10) Pub. No.: US 2026/0346423 A1
(43) Pub. Date: Nov. 5, 2026

(54) Perioperative Cobotic System with Bimodal Conveyance

(71) Applicant: Peritas AI Inc., Fort Lauderdale, FL (US)

(72) Inventor: Martin Roche, Fort Lauderdale, FL (US)

(73) Assignee: Peritas AI Inc., Fort Lauderdale, FL (US)

(21) Appl. No.: 19/366,536

(22) Filed: Oct. 23, 2025

Related U.S. Application Data
(63) Continuation-in-part of application No. 19/195,731, filed on Apr. 30, 2025.

(51) Int. Cl. B25J 5/00; B25J 9/00; B25J 9/12; B25J 9/16

(52) U.S. Cl. CPC B25J 5/007; B25J 9/0009; B25J 9/123; B25J 9/1676; B25J 9/1697

(57) ABSTRACT

A perioperative humanoid cobot is disclosed having bimodal locomotion for autonomous operation in surgical environments. The system includes articulated legs with integrated wheels enabling transitions between bipedal walking and wheeled rolling modes without external reconfiguration. A control system with an intelligence module fuses perception data from cameras, LiDAR, and force sensors to map surroundings, plan paths, and select locomotion mode based on terrain and task context. The cobot can step over obstacles, roll efficiently along corridors, or dock with a powered platform for extended range. Redundant sensing, geofencing, and fail-safe controls ensure safe operation near staff and sterile zones. Equipped with robotic arms and end effectors, the cobot performs transport, positioning, and perioperative support tasks under supervised or autonomous control, improving efficiency, safety, and workflow integration in hospital settings.

### CROSS-REFERENCE TO RELATED APPLICATIONS

This patent application is a continuation-in-part of U.S. patent application Ser. No. 19/195,731 filed on Apr. 30, 2025, which claims the benefit of priority to U.S. Provisional Patent Application No. 63/640,524, filed on Apr. 30, 2024, the entirety of which is incorporated herein by refer

### TECHNICAL FIELD

The present invention relates generally to cobotic systems, and more particularly to a perioperative cobotic system with bimodal locomotion capabilities, including both wheeled and bipedal modes of conveyance, for use in hospital environments.

### BACKGROUND

Hospitals and surgical centers present dynamic and spatially constrained environments that demand precision, adaptability, and efficiency in the movement of personnel, equipment, and assistive systems. Cobots, or collaborative cobots, have emerged as important tools in perioperative settings to support surgical teams in logistics, instrumentation, and procedural workflows. However, conventional cobotic systems have largely relied on either wheeled or tracked bases, which limits their maneuverability in environments with irregular flooring, thresholds, or obstructions. Wheeled systems, while efficient on flat, open surfaces, are unable to traverse steps, reposition precisely in tight spaces, or interact robustly within cluttered surgical environments.

To address these challenges, there is a growing interest in cobotic systems capable of human-like mobility, particularly those that integrate bipedal locomotion. Bipedal systems offer enhanced versatility, enabling step-over capabilities, dynamic balance, and fine-grained positioning that are critical in surgical settings where sterile boundaries, patient positioning, and equipment layout present complex spatial constraints. Nonetheless, bipedal locomotion alone lacks the efficiency and speed of wheeled systems over long, obstacle-free corridors typical of hospital environments.

Moreover, perioperative cobotic systems generally need the autonomy and contextual awareness to operate safely and effectively in the perioperative space. Such autonomy and awareness can be improved by integrating multimodal sensor inputs, environmental mapping, or fail-safe protocols for sterile field protection and collision avoidance.

Accordingly, there is a need for a perioperative cobotic system that combines wheeled and bipedal locomotion in a single platform, and that is capable of autonomously selecting and executing transitions between these modes based on environmental conditions. Such a system would provide fast and stable transport across flat surfaces, together with precise and adaptive mobility for localized interactions, enabling safe and effective support for surgical workflows across the perioperative continuum.

### SUMMARY

The present disclosure relates to a perioperative cobotic system having a humanoid form factor and a novel bimodal locomotion mechanism that allows operation in both a bipedal walking mode and a wheeled rolling mode. The system includes articulated legs with integrated wheels, enabling the cobot to autonomously kneel or stand to transition between locomotion modes without external bases or manual intervention. This design combines the agility and obstacle-negotiation capability of legged motion with the efficiency and stability of wheeled motion.

An onboard control system integrates multimodal sensors—such as cameras, LiDAR, depth sensors, and tactile or force sensors—with an intelligence module employing artificial intelligence for perception, mapping, path planning, and mode selection. The cobot autonomously determines the optimal locomotion mode based on environmental and task context, facilitating efficient movement through surgical corridors and precise positioning within operating rooms.

The system further supports docking with a separate powered wheeled platform for extended range, load capacity, and long-distance transport. Safety mechanisms, including redundant sensors, environmental mapping, and sterile-zone geofencing, ensure reliable and compliant operation in perioperative environments.

By combining anthropomorphic manipulators, adaptive locomotion, and intelligent control, the disclosed perioperative cobotic system enhances workflow efficiency, safety, and human-robot collaboration in surgical and hospital settings.

### BRIEF DESCRIPTION OF DRAWINGS

The foregoing and other objects, features, and advantages of the invention will become more apparent from the following detailed description, taken in conjunction with the accompanying drawings, in which:

FIG. 1 is a perspective view of a perioperative cobotic system with bimodal conveyance, illustrating the illustrating a bipedal locomotion configuration.

FIG. 2 is a perspective view of a perioperative cobotic system with bimodal conveyance, illustrating the illustrating a wheeled locomotion configuration.

FIG. 3 is a block diagram of the control system, showing connections to the sensor suite, locomotion actuators, communication interface, and fail-safe safety systems.

FIG. 4 is a flow chart of a method for autonomous mode selection and navigation, including sensor-driven determination of locomotion mode, execution of transitions, and navigation with collision and sterile-field avoidance.

These drawings are provided for illustrative purposes only and should not be construed as limiting the invention to the specific embodiments shown and described herein. Variations and modifications to these embodiments will be apparent to those skilled in the art, and all such variations and modifications are intended to be included within the scope of this disclosure.

### DETAILED DESCRIPTION

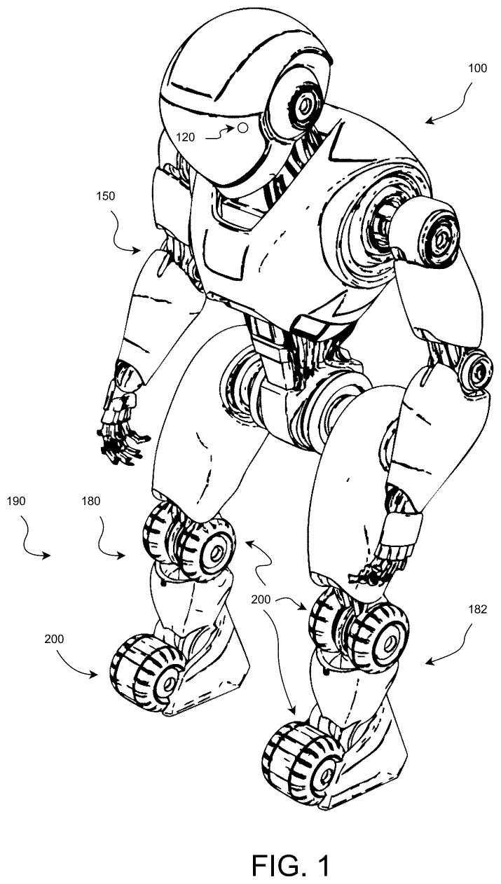

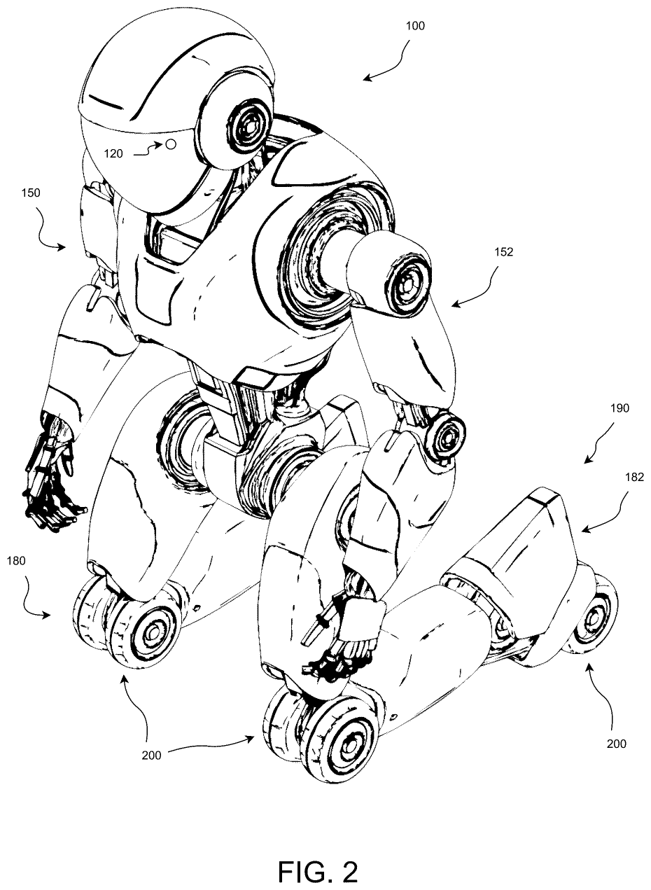

Referring now to the drawings, FIG. 1 illustrates an exemplary perioperative cobotic system 100 (referred to interchangeably as “cobotic system,” “cobot,” or “system”) in a humanoid form factor standing in a bipedal walking mode, and FIG. 2 illustrates the same system 100 reconfigured in a kneeling rolling mode. The system 100 includes a humanoid cobot body with a torso and limbs resembling those of a human. In the depicted embodiment, the cobot has one or more cobotic arms 150 (optionally a second arm 152) for manipulating surgical instruments, equipment, or other objects in a hospital environment. A variety of sensors are integrated into the cobot's body to perceive surroundings; for example, onboard perception system 120 (mounted in the head or upper body) provides visual feedback via a camera and/or additional sensors (such as depth sensors, LiDAR, or infrared detectors) that may be included to enhance environmental awareness. The humanoid cobot 100 is designed to operate alongside human staff in perioperative environments (e.g., operating rooms and surgical corridors) and features a novel bimodal locomotion mechanism enabling it to move either on two legs or on wheels, as described in detail below. This design allows the cobot 100 to safely and efficiently perform various perioperative tasks under both modes of movement-for instance, delivering surgical instruments, transporting sterile supplies, monitoring the OR environment, or repositioning equipment. The system 100 can be operated under human supervision or in an autonomous mode; initially a human operator may control or oversee the cobot 100, and eventually the cobot 100 may be capable of operating autonomously in an operating room.

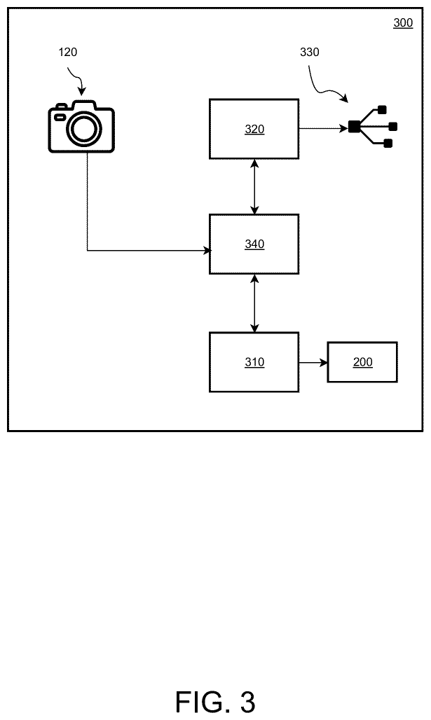

In one mode of locomotion, illustrated in FIG. 1, the cobotic system 100 operates as a bipedal cobot walking on two legs 180, 182, collectively referred to as legs or leg assembly 190. Each cobotic leg 180, 182 includes multiple joints (e.g. hip, knee, and ankle joints) actuated by a series of motors or other actuators, enabling the system to mimic a human gait. In this upright configuration, the cobot 100 can step over or traverse irregular surfaces commonly found in perioperative settings. For example, the cobot 100 is capable of stepping over door thresholds, cables and tubing on the floor, or small pieces of equipment that may be on an operating room floor, scenarios where a purely wheeled cobot might be hindered. Embedded sensors in the legs 190, such as joint angle encoders, gyroscopes, accelerometers, and force or pressure sensors at the feet, continuously monitor the cobot's balance, posture, and contact with the ground. The control system 300 (illustrated in FIG. 3) uses these sensor inputs to adjust each step in real time, ensuring dynamic stability during walking. For instance, if the cobot 100 is jostled by a person or if it steps on a slightly slippery surface, the control system can immediately compensate by shifting weight or altering the next foot placement. This active balance control allows the cobot 100 to remain stable even when perturbed or when moving on inclined surfaces. In some embodiments, the legged locomotion subsystem could include more than two legs-for example, a quadrupedal configuration-to further increase stability while still allowing traversal of complex terrain. The principles of bimodal conveyance apply similarly to such variants, with the cobot having multiple leg supports and the ability to switch to an alternative locomotion system as described below. In general, the bipedal mode provides the cobot with human-like mobility and height, enabling it to navigate tight spaces (like around operating tables) and to adjust its vantage point or reach by crouching or standing taller as needed for a given task.

In a second mode of locomotion, illustrated in FIG. 2, the cobot 100 transitions into a wheeled configuration by dynamically kneeling to engage built-in wheels 200 on its legs. The present system 100 integrates the wheels 200 directly into the humanoid's leg assembly, allowing mode transitions without any external base. In the depicted embodiment, each leg 180, 182 incorporates two or more wheels 200. For example, wheels 200 are embedded in or attached to the foot portions of the legs, and additional wheels are integrated into the knee sections. When the cobot transitions to wheeled locomotion, it actuates its leg joints (primarily the hip and knee joints) to move into a kneeling or crouched posture that brings at four or more wheels 200 into contact with the ground. In FIG. 2, the cobot 100 is shown in this kneeling wheeled configuration: the knees are bent and lowered toward the floor, and the torso is closer to the ground than in FIG. 1, such that the integrated wheels 200 on the shins and feet now support the cobot's weight. Once in this posture, the cobot 100 effectively rests on at least four contact points, forming a stable rolling base. Each wheel 200 is operatively connected to a dedicated drive motor 310, or alternatively a shared drive mechanism, so that the control system 300 can propel the cobot by applying torque to these wheels. In an embodiment, the wheels 200 may be outfitted with tires or treaded surfaces suitable for hospital flooring, providing good traction and smooth movement on hard, flat surfaces. This wheeled mode of locomotion enables stable, efficient and rapid travel over level ground: the cobot can move along hospital corridors, between operating theaters, or to storage areas much faster and with less energy expenditure than when operating in a bipedal mode. For instance, when carrying supplies from a storage room to an operating room, the cobot 100 might kneel into the wheeled mode and roll down a long hallway at a higher speed. Moreover, cobot 100 may enter into the wheeled mode when its battery is below a certain percentage to ensure safe emergency shutdown in case of sudden loss of power.

The locomotion in this mode can be configured as a differential drive or similar skid-steer system using the left and right sets of wheels-by varying the relative speed or direction of rotation of the wheels 200 on each side, the cobot 100 can steer and even turn in place. In some embodiments, omnidirectional wheels, for example, mecanum wheels or other holonomic wheel designs, may be used to allow side-to-side or holonomic movement, which can be advantageous for maneuvering in tight surgical or other perioperative spaces. During wheeled motion, the cobot's legs 190 can remain in the fixed kneeling configuration, effectively acting as a suspension or support frame. The lowered center of gravity in this mode provides enhanced stability, especially when the cobot is carrying a load such as an instrument tray. The leg joints may be locked or stiffened once the wheels are engaged to ensure rigidity, or alternatively, the control system may actively modulate the joints to keep all wheels in contact with the floor over uneven patches, serving as an active suspension. In this embodiment, no external base or manual reconfiguration is required for this transformation as the cobot seamlessly kneels down to deploy its wheels and stands back up to return to walking mode, all under its own power. When an obstacle or environmental feature is encountered where rolling is insufficient, for example, a staircase, a sudden change in floor height, or a cluttered area of the OR floor, the cobot can reverse the process: it will come to a stop, then use its leg actuators to lift itself from the kneeling position back to an upright bipedal stance, thereby disengaging the wheels from ground contact and resuming a walking gait. Transitions between modes are designed to be smooth, quick, and autonomous, without requiring any human intervention. In some embodiments, the wheels 200 could be retractable or have adjustable suspension, for instance, the wheels might slightly elevate or retract into the knees and feet when the cobot stands up, ensuring adequate ground clearance during walking and preventing the wheels from interfering with the legged gait. When the cobot kneels, those wheels extend or are simply positioned such that they become load-bearing. By integrating the wheeled capability directly into the legs, the system eliminates the complexity and time associated with physically docking to or detaching from a separate wheeled platform, improving reliability and responsiveness in dynamic environments.

In another embodiment, the cobot 100 selectively couples to a separate wheeled platform to obtain long-range, high-speed mobility without using integrated wheels 200. The platform includes motorized wheels (optionally omni-directional), a docking interface with alignment features (e.g., tapered funnels and guide pins or a three-point kinematic coupling), and an automatic locking mechanism (e.g., cam or bayonet latches) that secures to a complementary interface on the robot's pelvis or lower torso. A power/data coupler within the interface provides bidirectional electrical power and communications so that the platform's battery can power the robot and the robot's controller can command the platform drives. The robot autonomously approaches, aligns using onboard perception 120, and docks and interlock sensors confirm full seating and latch engagement before enabling platform motion. During docked operation, the controller may lock or impedance-stiffen the leg joints to form a rigid mast, retract or unload the integrated wheel modules, and coordinate braking and emergency-stop functions across both systems. The platform can include a low-profile lift or compliant cradle that supports the robot during docking/undocking, shock isolation to reduce transmitted vibration to carried instruments, and sterile-drape attachment points for perioperative use. This docked configuration may facilitate heavy payloads or corridor-length travel, while preserving the ability to undock and resume bipedal walking for obstacle negotiation or fine positioning near the sterile field.

The upper body and sensor suite of the cobot 100 enable it to interact intelligently with its surroundings and with human staff. As mentioned above, a perception system 120 is mounted in the cobot's head or on its torso to capture visual data from the environment. Perception system 120 may include conventional RGB video cameras for visible light, as well as other imaging modalities such as depth cameras or LiDAR scanners to obtain 3D spatial information, and infrared cameras for detecting heat signatures. Using this rich sensor data, the cobot 100 can perceive and map its environment: it can identify obstacles, recognize landmarks or key objects in an operating room (for example, the operating table, instrument trays, EKG carts), and detect the presence and movement of people to facilitate safe, fluid navigation. Proximity sensors such as ultrasonic rangefinders or time-of-flight sensors may also be placed around the cobot's base or limbs to detect nearby objects and provide redundancy for collision avoidance. The cobotic arms 150, 152 are equipped with suitable end effectors (such as grippers, cobotic hands, or tool-holding adapters) which may include force or tactile sensors. These sensors in the manipulators allow the cobot to delicately grasp surgical instruments, handle fragile supplies, or apply controlled force to push objects like carts or doors without causing damage. Overall, the physical configuration of system 100—combining anthropomorphic manipulators with adaptive locomotion modes—is intended to allow seamless integration into perioperative workflows. The cobot 100 can fetch and carry equipment or supplies, position cameras or lights for the surgical team, transport used instruments to sterilization, and even assist in turnover tasks like cleaning or setting up an operating room between procedures. Because the cobot can choose between walking or rolling locomotion as appropriate, it can move reliably through the dynamic hospital environment: for example, it might walk carefully around staff and sensitive equipment in the operating room (where precision is paramount), but then switch to faster wheeled travel to quickly cover the distance down a corridor to retrieve the next patient's materials. By adjusting its mode of movement on the fly, the cobot 100 facilitates flexibility, efficiency and safety in completing its tasks alongside humans.

Turning to the control architecture of the system, as illustrated in FIG. 3, the perioperative cobotic system 100 includes a sophisticated control system 300 that governs its sensors, interprets data, drives the actuators, and manages transitions between locomotion modes. The control system 300 typically comprises one or more processors and associated memory—an onboard computer or distributed processing units—running specialized software for autonomous navigation, perception, and task execution. The control system 300 receives input data from all of the cobot's sensors and monitors the state of all actuators in real time. For instance, sensor inputs may include the perception system 120, tactile feedback from end effectors, joint angle positions, e.g. encoder readings, and pressure readings from the leg sensors, wheel encoder readings and wheel motor currents from the integrated wheels, and proximity data from ultrasonic or infrared sensors around the cobot.

Using these inputs, an intelligence module 340 continually constructs and updates a model of the environment around the cobot 100 and the cobot's own pose within that environment. It performs functions such as mapping the surroundings (e.g., creating a 2D/3D map of the hospital corridors or operating room layout), detecting obstacles and uneven terrain, and localizing the cobot's position and orientation using techniques such as SLAM. The intelligence module 340 includes decision algorithms to determine the optimal locomotion mode (wheels vs. legs) based on the current context and environment.

The intelligence module 340 fuses synchronized perception data from perception system 120 with IMU outputs, wheel-encoder and motor-current telemetry from the wheel modules, joint position/torque signals from the hips, knees, and ankles, foot/wheel contact sensors, and tactile/force sensors on the end effector, into a unified state estimate and semantic map of the perioperative environment. The module employs artificial-intelligence techniques such as deep neural networks for object detection, semantic segmentation, human/pose recognition, and scene understanding; SLAM and probabilistic filtering for localization; and learned policies (e.g., reinforcement or imitation learning) combined with optimization-based planners (e.g., model-predictive control) to select between bipedal walking and wheeled modes and to generate collision-free trajectories. It outputs low-level commands including wheel-drive speed/torque setpoints, joint position/velocity/impedance targets for the legs during kneel/stand transitions, and coordinated motion/force trajectories for the cobot arms 150, 152 during manipulation. A safety arbiter enforces sterile-zone geofences, speed and torque limits, stability margins, and proximity thresholds, and an uncertainty monitor can slow, pause, or request operator input when confidence falls below a threshold. The module supports over-the-air model updates and on-device adaptation from logged data to improve perception and control while maintaining deterministic fail-safe interlocks. In the alternate docking embodiment, the same module coordinates the wheeled platform's propulsion and braking via the power/data interface and synchronizes emergency-stop behavior so the docked system operates as a single, coherent vehicle.

By processing sensor data, the system can autonomously decide when conditions favor wheeled movement and when a switch to bipedal walking is necessary. For example, if the path ahead is clear, flat, and free of obstacles for a significant distance, the control system may either keep the cobot in wheeled mode or initiate a transition to wheeled mode to take advantage of faster speed and efficiency. On the other hand, if the cobot's cameras and distance sensors detect an obstacle that wheels cannot easily overcome-such as a flight of stairs, a sudden floor elevation change above a predetermined threshold, or debris cluttering the corridor-the control system 300 will plan to switch into bipedal mode well in advance of reaching that obstacle. In essence, the cobot continuously analyzes its route and surroundings to autonomously select the appropriate locomotion mode, without requiring direct human commands for mode switching. This mode-selection logic can also account for mission-specific criteria; for instance, even if a path is clear, the cobot might choose to walk for finer positioning if it is very close to a sensitive area (like maneuvering around the operating table).

Once the control system 300 decides that a mode transition is needed, it coordinates the mechanical and electronic actions required to carry out the switch safely. If transitioning from wheeled mode to legged mode, the control system will first command the wheel drive motors to decelerate and bring the cobot to a controlled stop at a suitable location. It then engages the leg actuators to raise the cobot's body from the kneeling posture into an upright stance. During this process, the control system may gradually shift the cobot's weight from the wheels back to the feet-for example, it might extend the knees and hips in a controlled manner so that the feet (with their rubberized soles) progressively take on the load as the wheels lose contact with the ground. Once the cobot is fully standing, the wheels 130, 132 are lifted off the floor (or returned to a non-load-bearing state), and the cobot resumes bipedal walking. Conversely, if transitioning from bipedal walking to wheeled mode, the control system 300 will ensure the cobot is in a stable stance and that the immediate area is appropriate for engaging wheels (e.g., a flat, obstacle-free patch of floor). It then commands the leg joints to bend-lowering the torso and bringing the integrated wheels into ground contact-effectively transferring support to the wheels. When the wheels 130, 132 touch down and are supporting the cobot's weight, the control system may lock certain joints or otherwise stabilize the leg configuration, and then activate the wheel drive motors to begin rolling. Throughout either type of transition, various sensors provide feedback to the control system to guarantee a safe and reliable mode switch. For instance, pressure sensors or load cells in the legs can confirm that weight has shifted off or onto a given contact point; gyroscopes and accelerometers monitor the cobot's tilt and overall stability; and motor current sensors can indicate if a wheel is jammed or if a joint is encountering unexpected resistance. If any anomaly is detected during the transition (for example, if one wheel does not make proper contact with the ground, or if the cobot starts to tilt excessively), the control system 300 can automatically pause or abort the transition. In such a case, it will typically default the cobot to a safe state—for instance, stopping all motion and stiffening its joints to hold position—and issue an alert so that the situation can be addressed by a human operator if necessary. Once the new locomotion mode is successfully engaged, the control system seamlessly resumes navigation and normal operation in that mode.

During movement and mode transitions, the control system also manages obstacle avoidance, path planning, and adherence to hospital safety protocols. The cobot 100 is equipped with multiple layers of sensing to prevent collisions or unsafe interactions. It uses vision (camera 120), depth sensing (e.g. LiDAR or stereo cameras), and proximity sensors (ultrasonic or infrared) collectively to detect people, walls, furniture, or other equipment in its vicinity from all angles. The navigation software plans paths that circumvent obstacles and will adjust on the fly if a new obstacle appears. For example, if a person suddenly steps into the cobot's path, the cobot can slow or stop immediately, or steer around the person if there is space, all while maintaining a safe distance. The system 100 is also programmed to recognize and respect sterile fields and other restricted zones in a surgical environment. The control logic may define virtual exclusion zones (for instance, a radius around the operating table or instrument tray that is considered a sterile field), using either maps of the operating room or special markers/sensors that delineate such areas. The cobot will not enter or reach into those zones unless it has been explicitly authorized or assigned a task that requires it to do so in a controlled manner. This helps maintain infection control standards and prevents the cobot from inadvertently contaminating a sterile area or interfering with the surgical procedure. The ability to reliably avoid collisions and respect no-go areas is critical for a perioperative cobot, and system 100 employs redundant sensing and real-time monitoring by the control system 300 to achieve this level of safety.

The control system 300 further incorporates communication and learning capabilities to enhance the cobot's performance over time and to facilitate integration into the hospital's operational infrastructure. A wireless communication interface 320 (for example, a Wi-Fi and/or 5G transceiver) is included to allow the cobot 100 to transmit its status and receive external commands via a hospital network 330. In practical use, the system 100 can send real-time updates such as its current location, its locomotion mode (whether it is in wheeled mode or walking mode), and any alerts or exceptions (e.g., “obstacle detected, waiting for path to clear” or “transitioning to walking mode for stairs”) to a central monitoring station or to designated display devices in the hospital (such as a dashboard in the operating room control room or on a nurse's workstation). Hospital staff can thus be kept informed of the cobot's activities and intervene or redirect the cobot via the network if necessary. The communication interface 320 also allows the cobot 100 to tie into the hospital's information systems-for instance, it could receive task requests from a scheduling system (like being assigned to fetch a specific instrument for an ongoing surgery), or it could update an inventory management system when it delivers supplies. In some embodiments, multiple perioperative cobots may be deployed in the same facility and networked together. In such cases, the control system 300 can share data with other cobots and even coordinate actions (for example, splitting tasks or maintaining separation to avoid traffic jams in hallways). The software may utilize machine learning algorithms to improve performance with experience: for example, over time the cobot can learn which corridors or elevators tend to be congested at certain hours and adjust its routes or departure times accordingly, or it can refine the threshold criteria for switching to bipedal mode based on which obstacles actually required legged traversal in practice. Moreover, if multiple units are in communication, they can share their learned experiences with each other, either through direct cobot-to-cobot communication or via a cloud-based central system. When one cobot learns a more efficient path or develops a better strategy for handling a particular type of obstacle, that information can be propagated to the others, creating a collective learning network among the cobots. This distributed learning approach means that the performance of the system as a whole improves over time, without each unit needing to independently discover the same information. All these advanced capabilities remain under the supervision of the control system 300, which ensures that any adaptive behavior stays within the bounds of safety and reliability required in a surgical setting.

The system 100 is designed with multiple fail-safes and safety protocols to handle unexpected situations. An emergency stop mechanism is provided (either as a physical E-stop button on the cobot and/or as a remote command in the control software) which, when activated or when a hazardous condition is detected by the system, will immediately halt all motion of the cobot. Upon an emergency stop, the cobot can lock its joints and brakes on the wheels, effectively freezing in place to prevent any erratic movement. The control system 300 continuously monitors for conditions that should trigger a fail-safe response—for example, if an instability is detected (such as the cobot beginning to tip or a wheel losing traction in a way that could lead to a slip), or if critical sensors disagree about the cobot's position (indicative of a potential malfunction), the system will enter a safe mode. In a safe mode, the cobot might simply stop and maintain balance, or sit down slowly if balance cannot be maintained, and then await further instructions or assistance. The electrical and software architecture is built to default to safety: loss of communication, low battery, or other fault conditions will likewise cause the cobot to slow down and stop in a controlled manner. These safety features ensure that the perioperative cobot can operate reliably alongside humans, even in the busy, high-stakes environment of an operating room, without posing undue risk to people or to the surgical process.

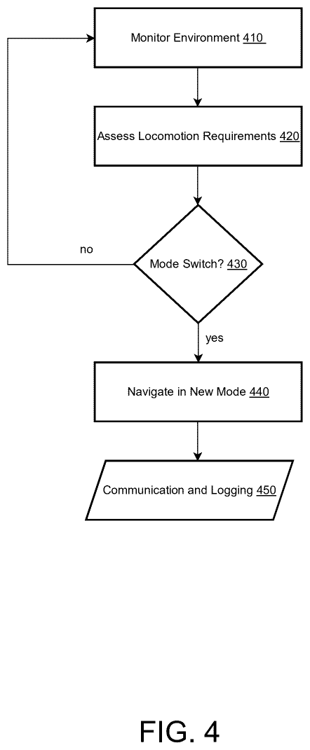

FIG. 4 illustrates a flow chart of an example autonomous locomotion mode management process executed by the control system 300 during operation of the cobot 100. This process outlines how the system senses its environment and decides when to switch between walking and rolling modes to navigate optimally through the hospital:

Monitor Environment 410: The control system continuously monitors input from the cobot's sensor suite to build situational awareness of the surroundings. This includes capturing visual data from the camera 120 and depth sensors, as well as reading distance measurements from LiDAR or ultrasonic sensors, and checking the current state of the ground surface via foot pressure sensors or wheel feedback. In real time, the system constructs a representation of the operating environment-detecting features such as floor conditions (e.g., flat tile vs. carpet or wet floor), identifying obstacles or people in the path, and recognizing the cobot's current location and target destination (for instance, knowing it is in Corridor A heading toward Operating Room Number 3).

Assess Locomotion Requirements 420: Using the aggregated sensor data, the control software analyzes the upcoming terrain and any obstacles to determine what locomotion capabilities will be required. The system considers factors like obstacle height, distance, and mobility constraints. For example, if the path ahead is largely open and level, the assessment might conclude that wheeled locomotion is sufficient and optimal for the next segment of travel. If a potential impediment is detected-such as an object on the floor, a gap, or a set of steps-the control system evaluates whether the current mode can handle it. Small obstacles or debris might be negotiable in wheeled mode by simply steering around them, whereas a staircase or an extended area of uneven flooring would necessitate switching to legged mode. The control system also accounts for the task context: if the cobot is approaching a precise delivery point (say, a specific spot in the operating room next to the operating table), it might plan to switch to walking mode for fine positioning, even if no large obstacles are present.

Decision-Mode Switch? 430: Based on the above assessment, the control system decides whether to maintain the current locomotion mode or to initiate a transition to the other mode. If no mode switch is needed (for instance, the environment ahead is still well-suited to whichever mode the cobot is currently in), the cobot 100 will continue traveling in the current mode and will simply navigate around minor obstacles as needed. The control loop then returns to continuously monitoring the environment, adjusting speed or path within the same mode. If a mode switch is determined to be necessary-for example, the system concludes that the cobot must switch to bipedal walking to step over an upcoming obstacle that wheels cannot traverse then the process proceeds to execute the transition.

Execute Transition 440: The cobot 100 performs the locomotion mode transition autonomously under the coordination of control system 300. In this step, the control system carries out the actions for switching modes, as previously described. If the cobot is currently in the wheeled (rolling) mode and needs to go to legged mode, it will decelerate and come to a controlled stop, stabilize itself, and then raise its body by driving its leg joints to stand up from the kneeling posture. As it stands, the wheels disengage from the ground and the cobot assumes full support on its feet, entering the walking configuration. If instead the cobot is walking and a switch to wheeled mode is needed, the control system will command the cobot to halt its walking, then smoothly lower itself by bending the legs until the integrated wheels touch down and support the weight. It then locks into the kneeling stance and activates the wheel drives. This transition step involves precise coordination of actuators and continuous sensor feedback to ensure everything aligns correctly. The control system verifies, for example, that the cobot's balance is maintained and that all wheels are properly in contact with the floor before it begins rolling, or that the cobot is fully supported by its legs before letting the wheels come off the ground. If any sensor indicates a problem (such as a wheel not making contact or an actuator overload), the control system can interrupt the transition and revert or adjust as needed. Once the transition is complete, the cobot switches its locomotion control to the newly engaged system (activating balance control algorithms for walking or enabling drive control for rolling, accordingly).

Navigate in New Mode 440: After completing the mode switch, the cobot 100 continues toward its destination using the new locomotion mode. The control system 300 updates or continues the navigation plan in light of the mode change. For example, if the cobot has just stood up into walking mode to handle a ramp or a set of steps, it will now proceed on foot to climb the ramp or stairs and to traverse the obstacle. Conversely, if the cobot has just knelt down into wheeled mode to cover a long, clear corridor, it will now accelerate and travel on wheels along that corridor toward the goal. During this movement in the new mode, the system returns to the continuous Monitor Environment step, looping through these decision-making steps again. The cobot keeps scanning for any new changes that might require further response (for instance, another obstacle that might necessitate yet another mode change or a stop).

Communication and Logging 450: Throughout the entire process, and especially after a mode transition or significant obstacle negotiation, the system 100 may generate status outputs and log data. In this step, the cobot transmits updates such as confirming that it successfully switched modes or overcame an obstacle, and reports its current state (e.g., “now in wheeled mode, resuming travel to destination”) via the communication interface 320 to whatever monitoring systems or personnel are tracking it. It may also log the event internally-for example, recording the location and nature of the obstacle, the decision it made, and the outcome. These logs can be valuable for offline analysis or continuous improvement of the cobot's performance. They contribute to the cobot's learning module, as data on what decisions were made and how well they worked can be used to fine-tune the mode-switching algorithm over time. They also provide a record for human operators or engineers to review in case of any incident or to optimize workflow (e.g., noting that a particular corridor often has clutter that causes the cobot to slow down or switch modes, which could prompt a change in hospital procedure or in the cobot's programming).

This flow chart in FIG. 4 represents an example of the decision-making loop that the control system 300 executes continuously during operation. In practice, the cobot's software is constantly iterating through these sensing and decision steps in real time, allowing the cobot to fluidly adapt its locomotion mode on the fly as conditions change. The ability to seamlessly transition between wheeled locomotion and bipedal walking in response to real-world conditions is a defining feature of the perioperative cobotic system with bimodal conveyance. It ensures that the cobot can efficiently cover long distances when the path is clear and also precisely maneuver in complex or cluttered environments when necessary. By combining human-like mobility (the agility of legs and anthropomorphic arms) with the efficiency of wheels and the precision of autonomous control, the system 100 enhances perioperative workflows while maintaining strict safety and sterility standards. Each element of the system, from the integrated leg-and-wheel locomotion hardware to the sensor-driven control algorithms, works in concert to provide a new level of versatility for cobotic assistants in surgical settings.

While specific embodiments of the perioperative cobotic system have been described in detail above, these examples are intended to be illustrative and not limiting. It will be understood that various modifications, substitutions, and improvements may be made by those skilled in the art without departing from the spirit or scope of the invention. Features described in the context of one embodiment may be combined with features of other embodiments in different permutations as appropriate. Furthermore, unless expressly stated otherwise, terminology used herein is for descriptive purposes and should be interpreted broadly: for example, the terms “comprising,” “including,” or “having” are to be read as open-ended and non-limiting, and the singular form of a term may encompass the plural form and vice versa. Similarly, unless the context clearly dictates otherwise, the term “or” is inclusive (meaning A, or B, or both) and “and/or” means any combination of the listed elements. The headings used in this description and the ordering of sections are provided for convenience of reference and do not limit the disclosure. The scope of the claimed subject matter, therefore, is defined solely by the claims that follow and any equivalents thereof, rather than by the specific examples given above.

While specific embodiments have been described to enable practice of the disclosed subject matter, they are illustrative and not limiting. Variations, modifications, substitutions, and combinations of the features described can be made by those skilled in the art without departing from the scope of this disclosure. Features described with respect to one embodiment may be used with, or substituted for, features of another. Unless expressly stated otherwise, the terms “comprising,” “including,” and “having” are used in an open, non-limiting sense; the singular forms “a,” “an,” and “the” include the plural forms; and stated ranges include their endpoints and all subranges. Unless the context clearly indicates otherwise, “and/or” means one or more of the listed items (e.g., “A and/or B” encompasses A alone, B alone, or both A and B); “or” is inclusive (i.e., “A or B” means A, B, or both); and “and” is conjunctive. Headings and ordering are for convenience and do not limit the description. The scope of the claimed subject matter is defined solely by the claims that follow and their legal equivalents.

What is claimed is:

1. A perioperative cobotic system with bimodal conveyance, comprising:
a wheeled locomotion base for providing wheeled mobility;
a bipedal locomotion assembly comprising two cobotic legs for providing bipedal mobility;
one or more actuators operatively connected to the wheeled locomotion base and the bipedal locomotion assembly, the one or more actuators being configured to effect transitions of the system between a wheeled locomotion mode and a bipedal locomotion mode;
one or more sensors configured to detect environmental conditions around the system; and
a control system configured to receive input from the one or more sensors and to control the locomotion of the system by selecting between the wheeled locomotion mode and the bipedal locomotion mode based on the detected environmental conditions.

2. The system of claim 1, wherein the one or more sensors comprise a camera, a LiDAR sensor, and an ultrasonic sensor to provide environmental mapping data and obstacle detection capability to the control system.

3. The system of claim 1, wherein the control system is configured to autonomously transition the system from the wheeled locomotion mode to the bipedal locomotion mode upon detecting an obstacle or floor elevation change exceeding a predetermined threshold, and to transition back to the wheeled locomotion mode when the path is clear of obstacles.

4. The system of claim 1, wherein the wheeled locomotion base comprises a docking mechanism configured to removably attach to the bipedal locomotion assembly, allowing the bipedal locomotion assembly to disengage from the wheeled base and operate independently in the bipedal locomotion mode.

5. The system of claim 1, wherein each of the two cobotic legs of the bipedal locomotion assembly includes multiple joints actuated by a plurality of motors, the joints being controlled to provide dynamic balancing and an adjustable step height so as to enable the system to step over floor obstacles and traverse uneven surfaces.

6. The system of claim 1, wherein the control system includes an autonomous navigation module configured to generate a map of the hospital environment using data from the one or more sensors and to plan and follow a path to a designated destination within a perioperative hospital environment.

7. The system of claim 1, further comprising a communication interface configured to transmit the system's operational status and mapping updates to a hospital information system and to receive supervisory commands from the hospital information system.

8. The system of claim 1, wherein the control system is configured to define one or more sterile-field zones within the perioperative environment and to restrict or override the system's movement to prevent the system from breaching a sterile field during operation.

9. The system of claim 1, further comprising an emergency stop mechanism configured to immediately halt all motion of the system in response to detecting a hazardous condition or receiving an emergency stop command, thereby ensuring fail-safe operation.

10. The system of claim 1, wherein the wheeled locomotion base includes a power supply and an electrical interface configured to provide power and data connectivity to the bipedal locomotion assembly when the bipedal locomotion assembly is docked on the wheeled base.

11. A mobile cobotic system capable of dual locomotion modes, comprising:
a wheeled locomotion base including a set of motorized wheels for providing wheeled movement;
a bipedal locomotion assembly comprising two cobotic legs;
one or more actuators associated with the coupling assembly and configured to lift the bipedal locomotion assembly into a walking position and to lower the bipedal locomotion assembly onto the wheeled locomotion base, thereby transitioning the system between a bipedal walking mode and a wheeled driving mode; and
a controller configured to control the one or more actuators and to coordinate operation of the wheeled locomotion base and the bipedal locomotion assembly during transitions between the locomotion modes.

12. The system of claim 11, wherein the one or more actuators comprise at least one motorized linear actuator configured to vertically raise and lower the bipedal locomotion assembly relative to the wheeled locomotion base during mode transitions.

13. The system of claim 11, wherein the one or more actuators comprise at least one motorized linear actuator configured to vertically raise and lower the bipedal locomotion assembly relative to the wheeled locomotion base during mode transitions.

14. The system of claim 11, wherein the coupling assembly includes alignment guides and an automatic locking mechanism to ensure proper positioning and secure attachment of the bipedal locomotion assembly to the wheeled base during docking, and to release the bipedal locomotion assembly for independent bipedal operation.

15. The system of claim 11, wherein the controller is configured to synchronize operation of the one or more actuators with movements of the cobotic legs to maintain stability during transitions between the wheeled locomotion mode and the bipedal locomotion mode.

16. The system of claim 11, wherein the wheeled locomotion base comprises a plurality of omni-directional wheels allowing movement in any direction to facilitate precise alignment for docking and improved maneuverability in confined hospital spaces.

17. A method of operating a cobotic system having both wheeled and bipedal locomotion modes, the method comprising:
monitoring, via one or more sensors, the environment surrounding the cobotic system;
automatically selecting, by a control system, a locomotion mode from among a wheeled locomotion mode and a bipedal locomotion mode based on the monitored environment;
transitioning the cobotic system between the wheeled locomotion mode and the bipedal locomotion mode by actuating one or more mechanical components of the system; and
navigating the cobotic system through the environment in the selected locomotion mode.

18. The method of claim 17, wherein automatically selecting the locomotion mode comprises detecting, via the one or more sensors, an upcoming obstacle or step of at least a predetermined height in the environment and switching the system from the wheeled locomotion mode to the bipedal locomotion mode in response to said detecting to enable the system to negotiate the obstacle.

19. The method of claim 17, further comprising continuously monitoring feedback from the one or more sensors during locomotion and dynamically adjusting one or more locomotion parameters of the system in real time based on the sensor feedback to maintain stability and avoid collisions while navigating.

20. The method of claim 17, further comprising transmitting, via a communication interface, data indicative of the system's operational status and environmental map to a hospital information system to facilitate integration of the cobotic system's activities with hospital operations.
